(19) United States
(12) Patent Application Publication
(10) Pub. No.: US 2026/0208274 A1
(43) Pub. Date: Jul. 23, 2026

(54) GUIDE ATTACHMENT

(71) Applicant: Salma Baig, Fremont, CA (US)

(72) Inventor: Salma Baig, Fremont, CA (US)

(21) Appl. No.: 19/031,910

(22) Filed: Jan. 18, 2025

(51) Int. Cl. B23B 51/00

(52) U.S. Cl. CPC B23B 51/0054

(57) ABSTRACT

A guide attachment for rotary tools, this invention features a body with a receiving portion at its back end and a guide portion movably attached to its front end. The receiving portion securely accommodates rotary tools, such as a drill chuck, through a circular or semi-circular entry point, and may be comprised of an elastic material for enhanced grip. The guide portion's angle relative to the body is adjustable, supported by angle markings for precision. The receiving portion can include a channel that narrows toward its front, ensuring a secure fit. Deflection surfaces extending from the body or guide portion manage debris during operation. This guide attachment enhances tool versatility, precision, and safety, making it ideal for various cutting and drilling applications.

### BACKGROUND

### Field of the Invention

The present invention relates generally to tool attachments, and, in particular, to a guide attachment having an adjustable guide portion.

### Scope of the Prior Art

Many guide attachments are designed to fit specific tool models or brands, creating issues for users with tools from multiple manufacturers. Traditional guides can also be bulky, obstructing visibility of the cutting area and reducing maneuverability, particularly in tight spaces. Insufficient stability is another drawback, with poorly designed or lightweight guides failing to provide adequate support, resulting in inaccurate cuts, tool drift, or chatter, especially on hard materials.

Many traditional guides offer limited or cumbersome mechanisms for adjusting depth, angle, or distance, restricting their flexibility for different tasks and materials. They often lack features for efficient debris management, leading to dust or chips obstructing the cutting path, reducing visibility, or damaging the tool. Furthermore, the added weight or altered balance from these guides can reduce ergonomics, causing user fatigue during prolonged use. Vibrational issues may also arise, as poorly designed guides can amplify tool vibrations, compromising both accuracy and comfort

### SUMMARY

One aspect of the present invention is directed at a guide attachment designed for use with rotary tools to enhance their precision and versatility during operation. The guide attachment comprises a body with a receiving portion extending from its back end and a guide portion movably attached to its front end. The receiving portion is configured to securely hold a portion of a rotary tool, such as the chuck of a drill, ensuring stability during use. The angle between the guide portion and the body is adjustable, allowing for customization to suit various applications.

The receiving portion may include a channel with an entry point and an exit point. Preferably, the perimeter of the entry point is larger than the perimeter of the exit point such that channel narrows towards the front end of the guide attachment. The channel, or a portion thereof, may be comprised of a flexible material.

The guide portion or body may include angle markings to provide visual cues for precise adjustments. Furthermore, the guide attachment can include a deflection surface extending from the body or guide portion, enhancing its functionality by directing debris.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is a perspective view of a guide attachment, according to a first embodiment.

FIG. 2 is a second perspective view of the guide attachment.

FIG. 3 is a back view of the guide attachment.

FIG. 4 is a left-side view of the guide attachment having received a rotary tool, according to an embodiment.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of an attachment for rotary tools, it will be recognized by those of ordinary skill that the present disclosure is not so limited. In fact, the principles of the present disclosure described herein may be readily applied to attachments for other types of tools.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

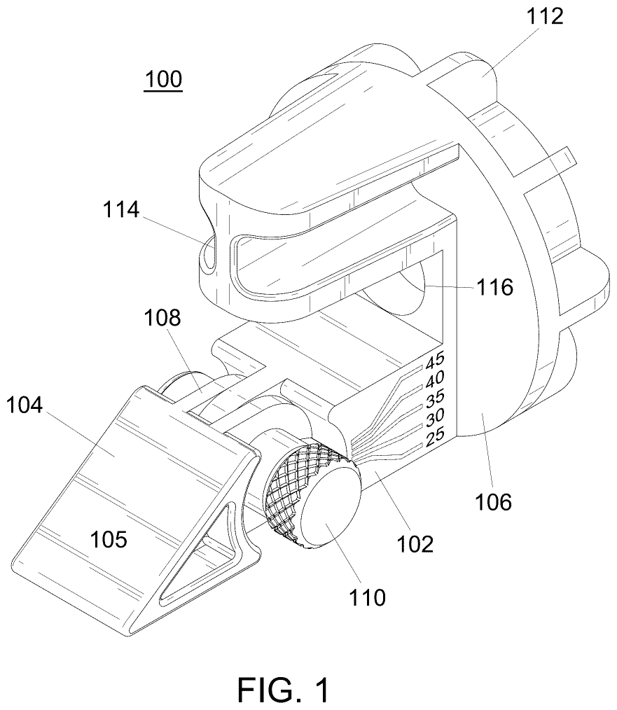

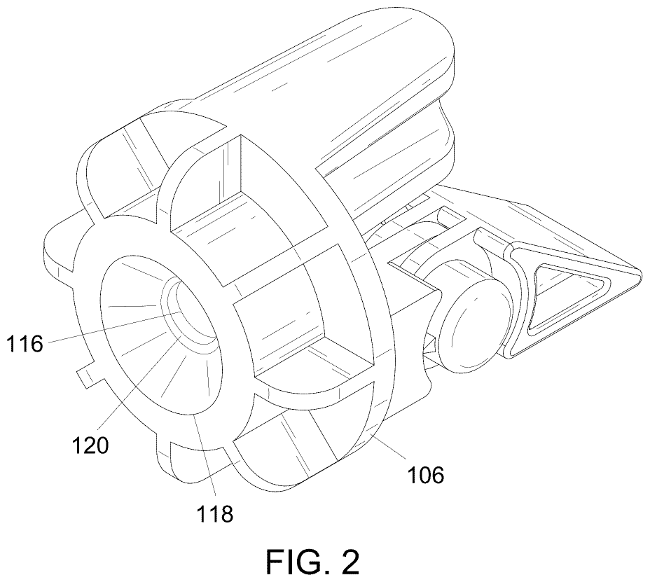

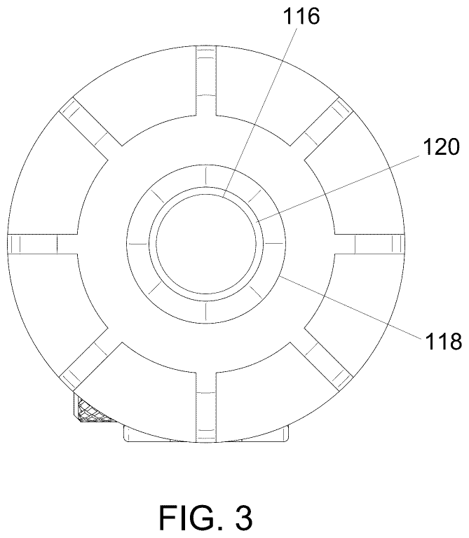

FIG. 1 is a front perspective view of a guide attachment 100, FIG. 2 is a back perspective view of the guide attachment 100, and FIG. 3 is a back view of the guide attachment 100, according to an embodiment. The guide attachment 100 may comprise a body 102, a guide portion 104, and a receiving portion 106.

The body 102 is designed to securely integrate and hold the other elements of the guide attachment 100 together. Preferably, the body 102 is crafted from a single, continuous block of solid material. Angle markings, or other visual indicators, can be positioned on the body 102, the guide portion 104, and/or the receiving portion 106. These angle markings indicate the angle between the guide portion 104 and the body 102, allowing the user to maintain a desired angle between the drum sander 126 and the work piece 128.

The guide portion 104 is movably attached to the front end of the body 102. Preferably, the guide portion 104 is rotatable relative to the body 102 via a hinge 108. Alternatively, a pivot joint, a ball-and-socket joint, a flexural joint, a rotary bearing, or any other mechanical joint that enables the guide portion 104 to be movably attached to the body 102 may be substituted. Preferably, a friction knob 110 on the hinge 108 locks the guide portion 104 in place when the friction knob 110 is engaged. Alternatively, a cam lock, a pin lock, clamping screws, a locking lever, or any other mechanical locking mechanism may be substituted.

The guide portion 104 can include a generally planar inner surface 105. The inner surface 105 is positioned against a work piece 128 when the guide attachment 100 is used with a rotary tool.

The receiving portion 106 extends from the back end of the body 102 and is configured to receive a rotary tool. Preferably, the receiving portion 106 includes a channel with a circular or semi-circular entry point 118 and a corresponding circular or semi-circular exit point 116. The perimeter of the entry point 118 may be equal to or greater than the perimeter of the exit point 116 such that the channel narrows towards the front end of the channel (towards the body 102). Alternatively, the channel includes a stopper portion 120 having a vertical or near-vertical slope. The shape of the channel prevents the front end of a rotary tool, such as the chuck of a drill, from extending through to the body 102.

In some embodiments, the receiving portion 106 can include a clamp, a cam lock, a pin lock, clamping screws, a locking lever, or any other mechanical locking mechanism to securely receive a rotary tool.

The receiving portion 106, or a portion thereof, can be comprised of an elastic material such as rubber. This elasticity enables the channel to constrict around a rotary tool, such as the chuck of a drill, when the rotary tool is inserted into the channel, thereby securely attaching the guide attachment 100 to the rotary tool through friction.

The guide attachment 100 may further comprise one or more deflection surfaces 114 extending from the body 102 and/or the receiving portion 106. The deflection surfaces 114 are strategically positioned to manage debris, guide materials, and protect the user. To catch metal shavings, the deflection surfaces 114 can be magnetic. To catch other debris, the deflection surfaces 114 can securely receive the end of a vacuum hose.

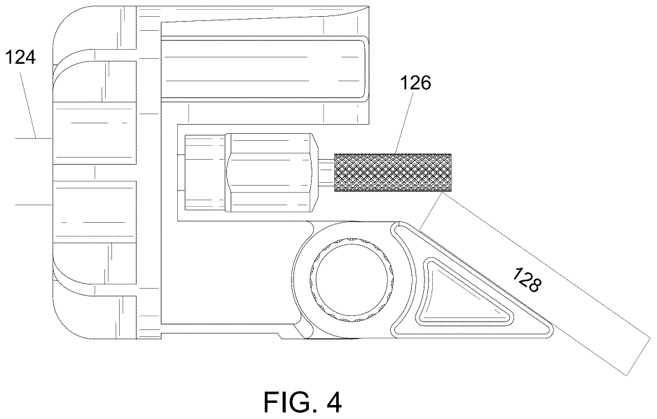

FIG. 4 is a left-side view of the guide attachment 100 having received the chuck 124 of a drill, according to an embodiment. The drum sander 126 extends past the exit point 116 of the receiving portion 106.

According to an embodiment, the guide attachment could feature a built-in dust collection port designed to connect seamlessly with standard vacuum hoses, effectively capturing debris during operation. For added flexibility, a detachable dust bag could be included for cordless or mobile use, keeping the work area cleaner and improving visibility.

According to an embodiment, a quick-release mechanism could allow for fast and secure attachment and removal of rotary tools without the need for additional tools. This mechanism could utilize a spring-loaded latch or magnetic coupling system to provide a firm grip while enabling swift tool changes.

According to an embodiment, incorporating an adjustable depth stop in the receiving portion would enable users to set a maximum cutting or drilling depth, ensuring consistent results across multiple passes. This feature would be particularly useful for tasks requiring precision, such as routing or controlled sanding.

According to an embodiment, a 360-degree swivel guide plate could be added to the guide portion, allowing users to easily maneuver the tool for curved or angled cuts. This added flexibility would enhance the tool's versatility in handling complex shapes and designs.

According to an embodiment, small, integrated LED lights positioned near the guide portion could illuminate the work surface, providing better visibility in dimly lit areas. This feature would improve precision and safety by allowing users to clearly see cutting or sanding lines.

According to an embodiment, adding a detachable or foldable ergonomic handle would provide additional control and comfort during use, especially for extended tasks. The handle could feature a non-slip grip, reducing user fatigue and enhancing precision.

According to an embodiment, integrating rubber or gel-based dampeners into the receiving portion would reduce the vibration transferred from the rotary tool to the user's hand. This would enhance comfort during prolonged use and contribute to more precise operation by minimizing tool chatter.

According to an embodiment, a built-in laser guide could project a straight or curved line onto the work surface, helping users align the tool precisely for cutting, drilling, or sanding. This feature would improve accuracy, especially when working on intricate designs or patterns.

According to an embodiment, the guide attachment could feature strategically placed vents or internal channels that direct airflow toward the tool bit, reducing heat buildup during prolonged use. This passive cooling system would extend the life of both the tool and the attachment.

According to an embodiment, wear-resistant plates made of durable materials could be attached to the guide portion and easily replaced when worn. This would protect the guide from excessive wear over time, extending the overall lifespan of the attachment.

According to an embodiment, the guide portion could include magnetic pads or suction cups on its base, allowing the attachment to securely adhere to metal or smooth surfaces. This feature would enable hands-free operation, improving stability and precision during use.

According to an embodiment, sensors embedded in the guide attachment could monitor vibration, temperature, or tool load, alerting the user to potential issues such as overheating or excessive force. Advanced versions might automatically reduce tool speed or shut off the tool to prevent damage and enhance user safety.

I claim:

1. A guide attachment comprising:
a body;
a receiving portion extending from a back end of the body;
a guide portion movably attached to a front end of the body;
wherein
the receiving portion is configured to securely receive a rotary tool; and
an angle between the guide portion and the body is adjustable.

2. The guide attachment of claim 1, wherein
the receiving portion is configured to securely receive a chuck of a drill.

3. The guide attachment of claim 1, wherein
the receiving portion includes a circular or semi-circular entry point.

4. The guide attachment of claim 1, wherein
at least one of the body and the guide portion includes angle markings.

5. The guide attachment of claim 1, wherein
the receiving portion includes a clamp.

6. The guide attachment of claim 1, further comprising:
a deflection surface extending from the body or guide portion.

7. The guide attachment of claim 1, wherein
the receiving portion is comprised, at least partially, of an elastic material.

8. The guide attachment of claim 1, wherein
the receiving portion includes a channel.

9. The guide attachment of claim 8, wherein
a perimeter of an entry point of the channel is greater than a perimeter of an exit point of the channel.

10. The guide attachment of claim 8, wherein
a perimeter of the channel narrows in towards a front end of the channel.
